(19) United States
(12) Patent Application Publication
(10) Pub. No.: US 2006/0176706 A1
(43) Pub. Date: Aug. 10, 2006

(54) Structure of lamp set

(76) Inventor: Chan-Hsing Chou, Sindian City (TW)

Correspondence Address: BIRCH STEWART KOLASCH & BIRCH, PO BOX 747, FALLS CHURCH, VA, 22040-0747, US

(21) Appl. No.: 11/049,737

(22) Filed: Feb. 4, 2005

(51) Int. Cl. F21V 19/00

(52) U.S. Cl. 362/382

(57) ABSTRACT

The invention discloses a structure of improved lamp set, which employs a simple adhesive technique combining with a gas discharge technique. First, two external cases with either regular shape or irregular shape are applied, in which luminous layers formed by fluorescent material are located at the inner wall of the external cases. Then, an adhesive substance is provided at the inner wall of the external cases, so that an enclosed space can be formed by adhesive bonding two external cases. Also, discharge response gas can be provided inside the enclosed space. Thus, a simple-structured gas discharge lamp set is completed.

### FIELD OF THE INVENTION

The present invention relates to an improved structure of lamp set and, more particularly, to a gas discharge lamp formed by adhesive bonding technique.

### BACKGROUND OF THE INVENTION

Gas discharge technique has been largely enhanced due to fast development in display screen. The essence of gas discharge technique is to sinter two light-transmittable glass panels by means of crystallized glass soldering technique, and then to form a gas discharge lamp by evacuating air and filling in inert gas. Then, at least one pair of discharge electrodes with voltage difference will be connected to the inner portion or outer portion of the air discharge lamp. After that, voltage difference in the discharge electrodes can ionize the discharge response gas. The ionizing process can activate the luminous layers formed by fluorescent material and generate light source. In the end, the light source will be used as backlight for the liquid crystal display screen and provide display light source.

However, the conventional gas discharge technique is high in manufacturing cost because it is confined by two factors. One factor is that the technique has to employ low-temperature crystallized glass sintering technique, and the other factor is that voltage difference in the discharge electrodes has to be increased in corresponding to the increasing size of display screen. In order to satisfy these two factors, the manufacturing cost has to be increased, and in turn the high cost can hinder the technique from being applied to the average-sized lamps. In addition, although the sintering technique allows the crystallized glass to be congealed at a low temperature, a crack on the glass panel is often an accompanied result as well. Therefore, gas discharge technique is not an ideal method to be applied to the average lamps.

### SUMMARY OF THE INVENTION

The object of the present invention is to employ an adhesive bonding method instead of low-temperature glass sintering method to adhere the external cases of a lamp set, so that the aforementioned problems can be solved. The lamp set of the present invention is formed by two external cases closely joined through adhesive bonding, wherein a luminous layer formed by fluorescent material is located inside the external case; also, an enclosed space is formed, surrounded by the joined faces of external cases, wherein discharge response gas is provided inside the enclosed space so that the discharge response gas can be activated by the discharge electrodes located in either the inner or outer portion of the lamp set so as to generate light source; therefore, a lamp set low in manufacturing cost as well as easy to be assembled is completed.

### BRIEF DESCRIPTION OF THE DRAWINGS

FIG. 1 is a schematic diagram illustrating an exploded external view of the first embodiment of the present invention.

FIG. 2 is a schematic diagram illustrating an exploded external view of the second embodiment of the present invention.

FIG. 3 is a schematic diagram illustrating a sectional structure of the present invention.

FIGS. 4A and 4B are schematic diagrams illustrating the third embodiment of the present invention.

FIG. 5 is a schematic diagram illustrating the fourth embodiment of the present invention.

FIG. 6 is a schematic diagram illustrating the fifth embodiment of the present invention.

### DETAILED DESCRIPTION OF THE PREFERRED EMBODIMENTS

The technical contents and detailed descriptions of the present invention will be better understood through descriptions of the following embodiments with reference to the drawings.

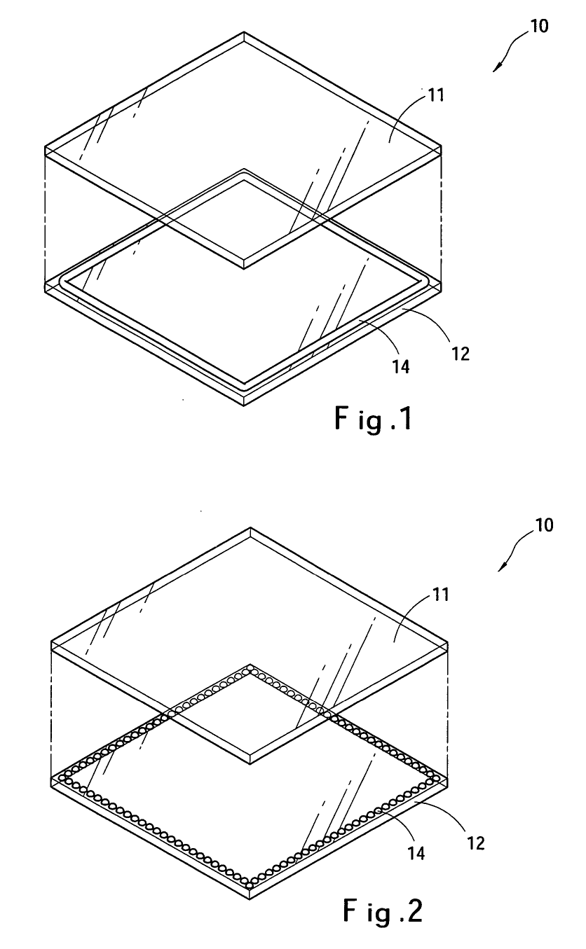

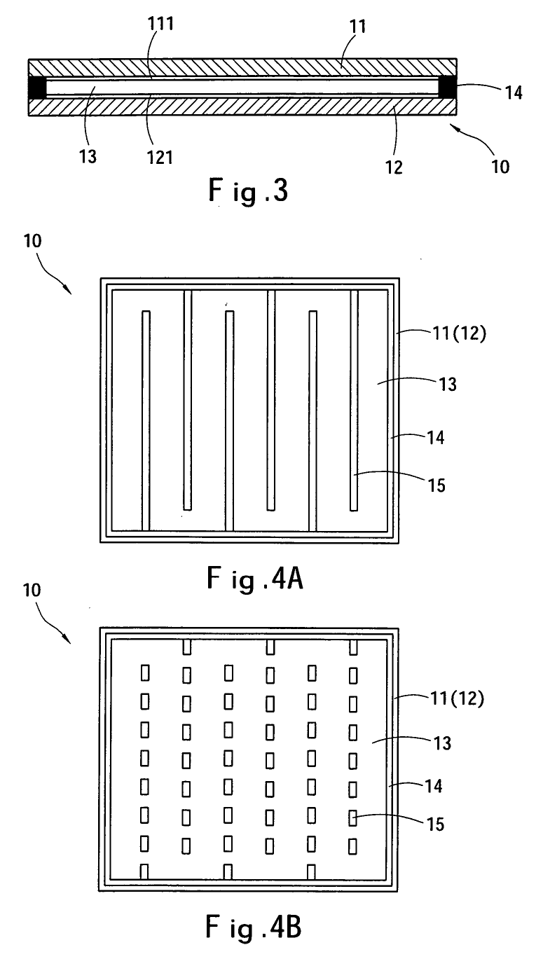

Referring to FIGS. 1, 2, and 3, the present invention is a structure of lamp set 10, and its characteristic is that the lamp set 10 is formed by joining two external cases 11 and 12 through adhesive bonding. Also, luminous layers 111 and 121 composed of fluorescent material are located at the inner wall of the external cases 11 and 12 respectively. In addition, an enclosed space 13 is formed, which is surrounded by the joined faces of the external cases 11 and 12, and discharge response gas is provided inside the enclosed space 13. Besides, at least one pair of discharge electrodes that can generate voltage difference is located at either the inner wall or outer wall of the external cases 11 and 12. By utilizing voltage difference generated by the discharge electrodes, discharge response gas can be ionized, and the luminous layers 111 and 121 can be activated for generating light source.

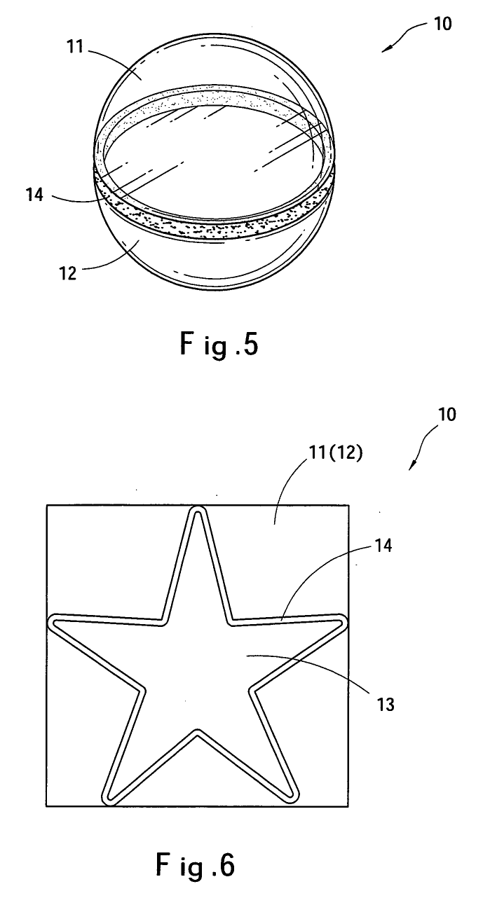

The adhesive bonding technique of the present invention may apply frame-shaped or bar-shaped adhesive substance 14 for face-to-face adhesive bonding to form lamp set 10, as shown in FIG. 1. Alternatively, spot-shaped adhesive substance 14 can also be applied for face-to-face adhesive bonding to form lamp set 10, as shown in FIG. 2. Before adhesive bonding, luminous layers 111 and 121 or inner-wall discharge electrodes will be coated or printed on the external cases 11 and 12. Alternatively, the luminous layers 111 and 121 on the external cases 11 and 12 can be produced with different designed patterns for decoration purpose to satisfy users' requirements. Also, as shown in FIGS. 4A and 4B, a plurality of backing ribs 15 can be added in for providing auxiliary support or segmenting light source, wherein the backing ribs 15 can be either spot-shaped or bar-shaped, with adhesive substance on their surfaces for adhesive bonding. Also, the method of providing light source for the light set 10 can be varied, depending on the material used for external cases 11 and 12, which can be transparent, semitransparent, or opaque. In addition, because the present invention employs adhesive bonding, material for the external cases 11 and 12 does not have to be glass material. Hardened plastic, for example, can be used instead. Moreover, as shown in FIG. 5, the design of external cases does not have to be square shape, either. Other design such as a ball shape, star shape, or other irregular shape can also be used for better aesthetic effects. Finally, the adhesive substance 14 of the present invention can be presented in a star shape, as shown in FIG. 6, or other irregular shape so that the luminous layers 11 and 121 and the enclosed space 13 located inside the external cases 11 and 12 can show a specific design of sectional luminescent effect, so as to enhance the product value of the present invention.

The embodiments above are only intended to illustrate the present invention; they do not, however, to limit the present invention to the specific embodiments. Accordingly, various modifications and changes may be made without departing from the spirit and scope of the present invention as described in the following claims.

What is claimed is:

1. An improved structure of lamp set, characterized by:
the lamp set which is formed by two external cases closely joined by means of adhesive bonding, wherein luminous layers formed by fluorescent material are located at the inner wall of the external cases; besides, an enclosed space is formed, which is surrounded by joined faces of the external cases, and discharge response gas is provided inside the enclosed space.

2. The improved structure of lamp set according to claim 1, wherein a joined position of the external cases is adhered in a face-to-face direction by applying frame-shaped adhesive substance so as to form the lamp set.

3. The improved structure of lamp set according to claim 1, wherein the joined position of the external cases is adhered in a face-to-face direction by applying bar-shaped adhesive substance so as to form the lamp set.

4. The improved structure of lamp set according to claim 1, wherein the joined position of the external cases is adhered in a face-to-face direction by applying spot-shaped adhesive substance so as to form the lamp set.

5. The improved structure of lamp set according to claim 1, wherein a plurality of backing ribs is provided inside the external cases for auxiliary support.

6. The improved structure of lamp set according to claim 1, wherein at least one pair of discharge electrodes for generating voltage difference is provided on the external cases.

7. The improved structure of lamp set according to claim 5, wherein the discharge electrodes are located at the inner wall of the external cases.

8. The improved structure of lamp set according to claim 5, wherein the discharge electrodes are located at the outer wall of the external cases.
